(19) United States
(12) Patent Application Publication
(10) Pub. No.: US 2023/0300551 A1
(43) Pub. Date: Sep. 21, 2023

(54) MULTI-CHANNEL IN-VEHICLE SOUND SYSTEM

(71) Applicant: NIO TECHNOLOGY (ANHUI) CO., LTD, Hefei City (CN)

(72) Inventors: Xiaolei SHI, Shanghai (CN); Chenwei SUN, Shanghai (CN); Rui ZHANG, Shanghai (CN)

(21) Appl. No.: 18/185,456

(22) Filed: Mar. 17, 2023

(30) Foreign Application Priority Data
Mar. 18, 2022 (CN) 202210266827.1

(51) Int. Cl. H04S 5/00

(52) U.S. Cl. CPC H04S 5/005; H04S 2400/01

(57) ABSTRACT

The disclosure relates to a multi-channel in-vehicle sound system, comprising: an audio processing device, a power amplifier, and a plurality of speakers, wherein the plurality of speakers comprise: a central speaker arranged in the center of the front of a vehicle cabin; a left speaker arranged in the left front of the vehicle cabin; a right speaker arranged in the right front of the vehicle cabin; a left surround speaker arranged on the left of the vehicle cabin; a right surround speaker arranged on the right of the vehicle cabin; a left front 3D speaker and a right front 3D speaker arranged on two sides of a roof and corresponding to the positions of front seats. for any one of the plurality of speakers, an azimuth compensation for the speaker is made by means of the speakers located around the speaker. According to the multi-channel in-vehicle sound system of the present disclosure, a more immersive sound field can be is provided, a better sound experience can be achieved, and the timbre can be better restored.

### CROSS-REFERENCE TO RELATED APPLICATIONS

This application claims the benefit of China Patent Application No. 202210266827.1 filed Mar. 18, 2022, the entire contents of which are incorporated herein by reference in its entirety.

### TECHNICAL FIELD

The disclosure relates to audio processing technology, and in particular to a multi-channel in-vehicle sound system.

### BACKGROUND

An in-vehicle sound system refers to an sound system installed inside a vehicle and comprises software and media, a sound source, a power amplifier, speakers and a transmission mechanism, etc. While the in-vehicle sound system is auxiliary equipment for a vehicle, as the experience of occupants is increasingly taken into consideration, increasingly higher requirements are made on the in-vehicle sound system. Moreover, while the configuration of an in-vehicle entertainment system is getting higher at present, the sound processing is not optimal, which is far from meeting a user’s requirements for the quality of the in-vehicle entertainment system.

On the other hand, stereo or 5.1 surround sound sources are used for most of current vehicle applications, which still cannot meet the requirement of immersive sound.

### SUMMARY

In view of the above problems, the disclosure aims to provide a multi-channel in-vehicle sound system capable of restoring the effect of a home theater.

The multi-channel in-vehicle sound system of the disclosure comprises: an audio processing device, a power amplifier, and a plurality of speakers, wherein the audio processing device is configured to distribute multi-channel audio to the plurality of speakers, the power amplifier is configured to amplify the power of an audio signal processed by the audio processing device, and the speakers are configured to play the distributed audio, and wherein the plurality of speakers comprise:
a central speaker arranged in the center of the front of a vehicle cabin;
a left speaker arranged in the left front of the vehicle cabin;
a right speaker arranged in the right front of the vehicle cabin;
a left surround speaker arranged on the left of the vehicle cabin;
a right surround speaker arranged on the right of the vehicle cabin; and
a left front 3D speaker and a right front 3D speaker arranged on two sides of a roof and corresponding to the positions of front seats; and
in the case of a blockage between one of the plurality of speakers and an occupant, an azimuth compensation for the speaker is made by means of the speakers located around the speaker.

Optionally, the plurality of speakers further comprise:

a left rear 3D speaker and a right rear 3D speaker arranged on two sides of a roof and corresponding to the positions of rear seats.

Optionally, the plurality of speakers further comprise:
a left rear surround speaker arranged on the left rear of the vehicle cabin; and
a right rear surround speaker arranged on the right rear of the vehicle cabin.

Optionally, an azimuth compensation for the speaker being made by the speakers located around the speaker comprises:

realizing the azimuth compensation by adjusting one or more of gain frequency, frequency, and phase of the speakers around the speaker.

Optionally, when the occupant is in the driver’s seat, the central speaker, the right front 3D speaker, the left surround speaker and the left rear 3D speaker are used to make the azimuth compensation for the left front 3D speaker.

Optionally, in the case of the blockage between the left rear 3D speaker and a hearer, the left surround speaker, the left speaker and the left front 3D speaker are used to make the azimuth compensation.

Optionally, the left speaker, the right speaker, the left surround speaker and the right surround speakereach employ a 3-frequency division, including treble, alto and bass;
the left rear surround speaker and the right rear surround speaker each employ a 2-frequency division, including treble and alto; and
the left front 3D speaker and the right front 3D speaker each employ a 2-frequency division, including treble and alto.

Optionally, the bass the left front 3D speaker is compensated by means of the bass of the left speaker.

Optionally, the left speaker, the right speaker, the left surround speaker and the right surround speaker each are composed of three independent speakers, that is, a treble speaker, an alto speaker, and a bass speaker;
the left rear surround speaker and the right rear surround speaker each are composed of two independent speakers, that is, a treble speaker and an alto speaker; and
the left front 3D speaker and the right front 3D speaker each are composed of two independent speakers, that is, a treble speaker and an alto speaker.

Optionally, the left front 3D speaker, the right front 3D speaker, the left rear 3D speaker and the right rear 3D speaker each are arranged at positions above 90% of a preset average height in a sitting posture.

As mentioned above, according to the multi-channel in-vehicle sound system of the present disclosure, a more immersive sound field is provided, a better sound experience can be achieved, and the timbre is better restored, so that occupants in the sound field can have an ampler 3D immersion Dolby Atmos experience.

### BRIEF DESCRIPTION OF THE SEVERAL VIEWS OF THE DRAWINGS

FIG. 1 represents a schematic structural diagram of a multi-channel in-vehicle sound system in the prior art.

FIG. 2 represents a schematic diagram of the arrangement of speakers of a multi-channel in-vehicle sound system according to an implementation of the disclosure.

FIG. 3 represents a schematic diagram of azimuth compensation and bass compensation of the multi-channel in-vehicle sound system according to an implementation of the disclosure.

### DETAILED DESCRIPTION

Some of the embodiments of the disclosure are described below and are intended to provide a basic understanding of the disclosure. They are not intended to confirm key or decisive elements of the disclosure or limit the scope of protection.

For concise and illustrative purposes, this specification mainly describes the principles of the disclosure with reference to its exemplary embodiments. However, those skilled in the art will readily recognize that the same principles are equivalently applicable to and can be implemented in all types of multi-channel in-vehicle sound systems, and that any such variations do not depart from the true spirit and scope of this patent application.

In addition, in the following description, reference is made to the accompanying drawings, which illustrate specific exemplary embodiments. Electrical, mechanical, logical, and structural changes can be made to these embodiments without departing from the spirit and scope of the disclosure. Furthermore, although the features of the disclosure are disclosed in combination with only one of several implementations/embodiments, if any given or recognizable function may be desired and/or advantageous, this feature can be combined with one or more other features of other implementations/embodiments. Therefore, the following description should not be considered in a limiting sense, and the scope of the disclosure is defined by the appended claims and their equivalents.

The terms such as “have” and “include” indicate that in addition to the units (modules) and steps that are directly and clearly described in the specification and the claims, other units (modules) and steps that are not directly or clearly described are not excluded in the technical solutions of the disclosure.

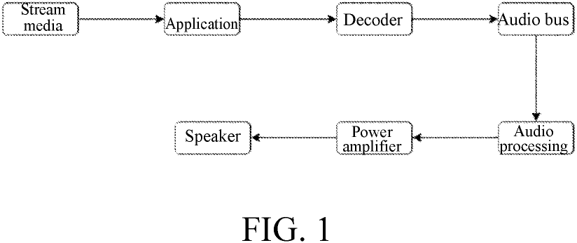

FIG. 1 represents a schematic structural diagram of a multi-channel in-vehicle sound system in the prior art.

As shown in FIG. 1, in the multi-channel in-vehicle sound system in the prior art, streaming media (or can me also replaced by local media, such as USB) play is used for an application, in which an undecoded audio stream is transmitted to a decoder, or uncoded audio bypasses the decoder and is directly transmitted to a next stage. The decoder comprises, but is not limited to, a multi-channel format, such as Dolby Atmos, DTS X and Auro 3D. An audio bus is used for audio transmission between different modules, can be located in other positions in the audio stream as shown in FIG. 1, and comprises, but not limited to, A2B, Most, Ethernet and other means.

In the disclosure, the so-called audio processing refers to distributing multi-channel audio to different power amplifier channels of corresponding speakers in the vehicle. The multi-channel in-vehicle sound system of the disclosure mainly comprises: an audio processing device, a power amplifier, and a plurality of speakers. The audio processing device is configured to distribute multi-channel audio to the plurality of speakers, the power amplifier is configured to amplify the power of an audio signal processed by the audio processing device, and the speakers are configured to play the distributed audio.

Firstly, the arrangement of the speakers of the multi-channel in-vehicle sound system according to an implementation of the disclosure will be described.

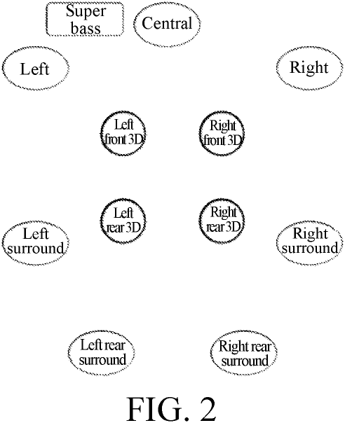

FIG. 2 represents a schematic diagram of the arrangement of speakers of a multi-channel in-vehicle sound system according to an implementation of the disclosure.

As shown in FIG. 2, the speakers are arranged according to the 7.1.4 channel scheme:
“7”: there are arranged respectively a left speaker, a central speaker, a right speaker, a left surround speaker, a right surround speaker, a left rear surround speaker and a right rear surround speaker (indicated respectively by left, central, right, left surround, right surround, left rear surround and right rear surround in FIG. 2);
“4”: there are arranged respectively a left front 3D speaker, a right front 3D speaker, a left rear 3D speaker and a right rear 3D speaker (indicated respectively by left front 3D, right front 3D, left rear 3D and right rear 3D in FIG. 2);
“1”: a super bass speaker (indicated by super bass in FIG. 2).

The central speaker is arranged in the center of the front of a vehicle cabin. The left speaker is arranged in the left front of the vehicle cabin. The right speaker is arranged in the right front of the vehicle cabin. The left surround speaker is arranged on the left of the vehicle cabin. The right surround speaker is arranged on the right of the vehicle cabin. The left rear surround speaker is arranged in the left rear of the vehicle cabin. The right rear surround speaker is arranged in the right rear of the vehicle cabin.

The left front 3D speaker and the right front 3D speaker are arranged on two sides of a roof and corresponding to the positions of front seats, and the left rear 3D speaker and the right rear 3D speaker are arranged on two sides of the roof and corresponding to the positions of rear seats.

In particular, the left front 3D speaker, the right front 3D speaker, the left rear 3D speaker and the right rear 3D speaker each can be arranged at positions above 90% of a preset average height in a sitting posture. As an example, assuming that people have an average height of 175 cm, and have an average height between about 55 to 65 cm in a sitting posture, the left front 3D speaker, the right front 3D speaker, the left rear 3D speaker and the right rear 3D speaker each can be arranged at levels from 49.5 cm to 58.5 cm or above (from a surface of a seat ). As an example, the left front 3D speaker, the right front 3D speaker, the left rear 3D speaker and the right rear 3D speaker can also not be arranged at positions higher than the occupant’s ears but are not too close to the ears. In this way, according to the arrangement positions of the left front 3D speaker, the right front 3D speaker, the left rear 3D speaker and the right rear 3D speaker, the sound having a “height” can be used to create a three-dimensional wide sound field.

Due to the limitations of the in-vehicle layout and the sizes of the speakers, each channel not only needs the speaker in the channel’s own position to play, but also needs to be supplemented by surrounding speakers to accurately position the sound and restore the timbre. Then, the azimuth compensation and the bass compensation of the multi-channel in-vehicle sound system of the disclosure will be described.

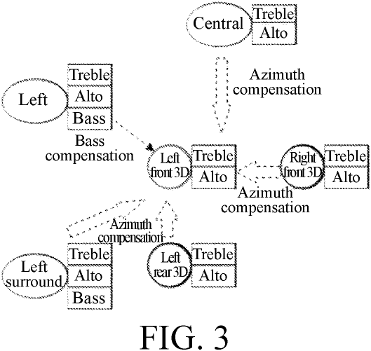

FIG. 3 represents a schematic diagram of azimuth compensation and bass compensation of the multi-channel in-vehicle sound system according to an implementation of the disclosure.

Firstly, the azimuth compensation made by the multi-channel in-vehicle sound system of the disclosure is described.

The inventors of the disclosure have found that, in the case of a blockage between a speaker and an occupant, the effect of a home theater cannot be completely restored. In order to solve this problem, the disclosure provides a method for azimuth compensation using other speakers located around the speaker.

The azimuth compensation can be divided into two categories:
one is blockage compensation; and
the other one is distance compensation, i.e., a compensation in which when the distance between the speaker and the occupant is too small, in order to prevent human ears from positioning the sound very close, the sound field is moved further away.

As regard to the blockage compensation, specifically, in the case of a blockage between one of the plurality of speakers and the occupant, the speakers located around the speaker can be used to make the azimuth compensation for the speaker. As a specific implementation of the azimuth compensation, the azimuth compensation is realized by adjusting one or more of gain frequency, frequency,and phase of the speakers located around the speaker.

As an example of the blockage compensation in the azimuth compensation, for example (not shown), in the case of a blockage between the occupant in the driver’s position and left rear 3D speaker (such as blockage by the driver’s seat), the left surround speaker, the left speaker and the left front 3D speaker are used to make the azimuth compensation.

As regard to the distance compensation, specifically, in the case of a too small distance between one of the plurality of speakers and the occupant, the speakers located around the speaker can be used to make the distance compensation for the speaker. As a specific implementation of the azimuth compensation, the azimuth compensation is realized by adjusting one or more of gain frequency, frequency, and phase of the speakers located around the speaker.

Specifically, as an example of the distance compensation in the azimuth compensation, for example, as shown in FIG. 3, when the occupant is in the driver’s seat, the distance between the left front 3D speaker and the occupant is too small, and in order to move the sound away, the central speaker, the right front 3D speaker, the left surround speaker and the left rear 3D speaker are used to make the azimuth compensation for the front 3D speaker.

In this way, by means of the azimuth compensation by the surrounding speakers, the position of the sound can be accurately located, thereby perfectly restoring the timbre.

Then, a bass compensation of the multi-channel in-vehicle sound system of the disclosure will be described.

In this implementation, the left speaker, the right speaker, the left surround speaker and the right surround speaker for the speaker each employ a 3-frequency division, including treble, alto and bass.

The left rear surround speaker and the right rear surround speaker each employ a 2-frequency division, including treble and alto. The left front 3D speaker and the right front 3D speaker each employ a 2-frequency division, including treble and alto.

In this way, the bass of the left speaker can be used to compensate the bass of the left front 3D speaker, and thus the timbre can be restored more completely.

Further, In this implementation, in order to better restore the timbre, the speakers can further be configured as follows:

the left speaker, the right speaker, the left surround speaker and the right surround speaker each are composed of three independent speakers, that is, a treble speaker, an alto speaker, and a bass speaker; the left rear surround speaker and the right rear surround speaker each are composed of two independent speakers, that is, a treble speaker and an alto speaker; the left front 3D speaker and the right front 3D speaker each are composed of two independent speakers, that is, a treble speaker and an alto speaker; and the left rear surround speaker and the right rear surround speaker each are composed of two independent speakers, that is, a treble speaker and an alto speaker; With the combination of such multiple groups of speakers, a three-dimensional sound effect can be improved, and the sense of reality of the sound can be significantly improved.

Thus, with the configuration of the plurality of speakers, complete surround sound can be realized, so that the sound can surround the occupant in all directions, so as to enable the occupant to have the experience of a home theater.

As mentioned above, according to the multi-channel in-vehicle sound system of the present disclosure, a more immersive sound field can be is provided, a better sound experience can be achieved, and the timbre can be better restored, so that the occupants in the sound field can have an ampler 3D immersion Dolby Atmos experience.

The above examples mainly illustrate the multi-channel in-vehicle sound system of the disclosure. Although only some specific implementations of the disclosure are described, a person of ordinary skill in the art should understand that the disclosure may be implemented in many other forms without departing from the essence and scope of the disclosure. Accordingly, the represented examples and implementations are considered to be illustrative rather than restrictive, and the disclosure may encompass various modifications and replacements without departing from the spirit and scope of the disclosure that is defined by the appended claims.

1. A multi-channel in-vehicle sound system, comprising: an audio processing device, a power amplifier, and a plurality of speakers, wherein the audio processing device is configured to distribute multi-channel audio to the plurality of speakers, the power amplifier is configured to amplify the power of an audio signal processed by the audio processing device, and the speakers are configured to play the distributed audio, and wherein the plurality of speakers comprise:
a central speaker arranged in the center of the front of a vehicle cabin;
a left speaker arranged in the left front of the vehicle cabin;
a right speaker arranged in the right front of the vehicle cabin;
a left surround speaker arranged on the left of the vehicle cabin;
a right surround speaker arranged on the right of the vehicle cabin; and
a left front 3D speaker and a right front 3D speaker arranged on two sides of a roof and corresponding to the positions of front seats; and
for any one of the plurality of speakers, an azimuth compensation for the speaker is made by means of the speakers located around the speaker.

2. The multi-channel in-vehicle sound system according to claim 1, wherein the plurality of speakers further comprise:
a left rear 3D speaker and a right rear 3D speaker arranged on two sides of the roof and corresponding to the positions of rear seats.

3. The multi-channel in-vehicle sound system according to claim 2, wherein the plurality of speakers further comprise:
a left rear surround speaker arranged in the left rear of the vehicle cabin; and
a right rear surround speaker arranged in the right rear of the vehicle cabin.

4. The multi-channel in-vehicle sound system according to claim 3, wherein
an azimuth compensation for the speaker being made by the speakers located around the speaker comprises:
realizing the azimuth compensation by adjusting one or more of gain frequency, frequency, delay and phase of the speakers around the speaker.

5. The multi-channel in-vehicle sound system according to claim 4, wherein in the case of a blockage between an occupant and the speaker, a blockage compensation is made as the azimuth compensation by means of one or more speakers around the speaker.

6. The multi-channel in-vehicle sound system according to claim 4, wherein in the case of a too small distance between the occupant and the speaker, a distance compensation is made as the azimuth compensation by means of one or more speakers around the speaker.

7. The multi-channel in-vehicle sound system according to claim 4, wherein
the left speaker, the right speaker, the left surround speaker and the right surround speaker each employ a 3-frequency division, including treble, alto and bass;
the left rear surround speaker and the right rear surround speaker each employ a 2-frequency division, including treble and alto; and
the left front 3D speaker and the right front 3D speaker each employ a 2-frequency division, including treble and alto.

8. The multi-channel in-vehicle sound system according to claim 7, wherein the bass of the left front 3D speaker is compensated by means of the bass of the left speaker.

9. The multi-channel in-vehicle sound system according to claim 7, wherein
the left speaker, the right speaker, the left surround speaker and the right surround speaker each are composed of three independent speakers, that is, a treble speaker, an alto speaker, and a bass speaker;
the left rear surround speaker and the right rear surround speaker each are composed of two independent speakers, that is, a treble speaker and an alto speaker; and
the left front 3D speaker and the right front 3D speaker each are composed of two independent speakers, that is, a treble speaker and an alto speaker.

10. The multi-channel in-vehicle sound system according to claim 2, wherein the left front 3D speaker, the right front 3D speaker, the left rear 3D speaker and the right rear 3D speaker each are arranged at positions above 90% of a preset average height in a sitting posture.
